(19) United States
(12) Patent Application Publication
(10) Pub. No.: US 2023/0374350 A1
(43) Pub. Date: Nov. 23, 2023

(54) SHEET MATERIAL

(71) Applicant: ESSENTRA PACKAGING AND SECURITY LIMITED, Milton Keynes Buckinghamshire (GB)

(72) Inventor: Darren CROWDER, Nottingham (GB)

(21) Appl. No.: 18/247,893

(22) PCT Filed: Oct. 6, 2021
(86) PCT No.: PCT/GB2021/052581

§ 371 Date: Apr. 5, 2023

(30) Foreign Application Priority Data
Oct. 6, 2020 (GB) 2015819.2

(51) Int. Cl. C09J 7/29; B32B 7/06; B32B 7/12; B32B 27/30

(52) U.S. Cl. CPC C09J 7/29; B32B 7/06; B32B 7/12; B32B 27/306; C09J 2429/006; C09J 2400/283; C09J 2400/286; C09J 2400/228; B32B 2307/7166; B32B 2405/00

(57) ABSTRACT

There is disclosed a sheet material 100 comprising: a core 104 comprising a water soluble polymer film layer 105, preferably comprising a polyvinyl alcohol polymer; a release agent 102 disposed on a first surface of the core 104; and an adhesive layer 108 disposed on a second surface of the core 104.

The present invention relates to a sheet material, tapes, packaging including the tapes, and their methods of production.

Single use plastic products present a growing environmental problem affecting the planet's oceans, rivers and other aquatic environments. Single use plastic products are products which are used once or used a small number of times and then discarded. Examples of single use plastic products include drinking straws, product packaging and carrier bags. Single use plastic products may be made from plastic materials that are recyclable; however, significant quantities of single use plastic products are disposed in landfill sites or make their way into rivers, lakes and oceans. Typical polymers used to create single use plastic products include polyethylene, polypropylene and polyester. Such polymers are not biodegradable and may form small beads or microparticles (so called microplastics) when exposed to the oceanic environment.

Research has been carried out to modify existing plastic products so that these are biodegradable, for example by composting processes. However, many of these polymers are not biodegradable in water and in anaerobic environments such as the deep ocean. Many biodegradable plastic materials are also not recyclable and can contaminate recyclable plastics causing problems for existing plastic recycling processes and infrastructure.

There is a need for new sheet materials that can be used to make products, such as product packaging and tapes, that retain similar performance to existing sheet materials based on polymers such as polyethylene and polypropylene, but are biodegradable in aquatic environments.

In a first aspect of the present invention, there is provided a sheet material comprising: a core comprising a water soluble polymer film layer; a release agent disposed on a first surface of the core; and an adhesive layer disposed on a second surface of the core.

The core may comprise a single water soluble polymer film layer. The core may comprise further layers that are different to the water soluble polymer film layer. The core may comprise one or more layers of ink, for example printed ink.

In the case of the core comprising only a water soluble film layer, then the release agent may be disposed on a first surface of the water soluble film layer, and the adhesive layer may be disposed on a second surface of the water soluble film layer.

Herein the term “disposed on a surface” means disposed on at least a part of the surface.

For example, the release agent may be disposed on at least part of a first surface of the core; and the adhesive layer may be disposed on at least part of a second surface of the core. The release agent may be disposed on the entire first surface of the core; and the adhesive layer may be disposed on the entire second surface of the core.

Utilising a water soluble polymer film in the core of the sheet material provides a sheet material which is biodegradable and that can dissolve in water.

The core may comprise a laminate comprising the water soluble polymer film layer, and a further layer. The further layer may, for example, be a further polymer film, for example a further water soluble polymer film. The further layer may comprise a cellulosic material, for example paper, Kraft paper, card, cardboard or the like. The further layer may be paper, for example Kraft paper.

The applicant has found that a laminate may impart improved mechanical properties and processability on the sheet material. For example, the further layer, e.g. paper, may help to strengthen the core. The core being a laminate may be particularly useful for applications in which the sheet material is used to form a tear tape that is adhered to a card or cardboard packaging substrate.

If the further layer is a paper material, for example paper, then the paper may have a basis weight of from 50 g/m² to 200 g/m², for example from 60 g/m² to 120 g/m², for example from 70 g/m² to 120 g/m², for example from 60 g/m² to 90 g/m², for example from 65 g/m² to 85 g/m², for example from 70 g/m² to 85 g/m², for example from 75 g/m² to 85 g/m², for example 77 g/m² or 82 g/m².

The paper may be normal wet strength (NWS) grade paper or low wet strength (LWS) paper. In the case of the further layer being a normal wet strength grade paper, then the basis weight may be from 70 g/m² to 79 g/m², for example from 75 g/m² to 79 g/m², for example 77 g/m².

In the case of the further layer being a low wet strength grade paper, then the basis weight may be from 78 g/m² to 85 g/m², for example from 78 g/m² to 82 g/m², for example 80 g/m².

The laminate may comprise a layer of lamination adhesive disposed between the water soluble polymer film layer and the further layer. The lamination adhesive may be a biodegradable adhesive. The lamination adhesive may be an aqueous adhesive. The aqueous adhesive may be a water born aqueous adhesive, for example a water born aqueous dispersion adhesive.

The lamination adhesive may be a solventless lamination adhesive. Herein, a solventless lamination adhesive is a lamination adhesive which does not include a water or other solvent carrier.

The applicant has found that when a hot melt lamination adhesive was used to form a laminate including a paper layer and a water soluble polymer film layer, the resulting sheet material exhibited poor re-pulpability performance when exposed to re-pulping conditions typically used to recycle paper products. Re-pulping is a recycling process which converts paper based products into pulp that can be used to produce new paper based materials. The applicant found that a solvent based lamination adhesive led to a very strong bond between the water soluble polymer film layer and the paper layer; however, the strength of the adhesion meant that the sheet material exhibited poor re-pulpabiltiy performance when exposed to re-pulping conditions typically used to recycle paper products.

The applicant found that a solventless lamination adhesive led to a sheet material having excellent strength and durability properties, while also being re-pulpable when exposed to re-pulping conditions typically used to recycle paper products.

Alternatively, the water soluble polymer film layer may be thermally bonded to the further layer. Thermal bonding may be achieved by co extrusion with the further layer, for example the water soluble polymer film may be co-extruded with a paper layer.

The core may comprise a layer of ink. The adhesive layer or the release agent may be disposed on the layer of ink. The ink may be printing ink, for example a gravure solvent based ink.

The layer of ink may be disposed on the water soluble polymer film layer. For example, the layer of ink may be disposed between the second surface of the water soluble polymer film layer and the adhesive layer. The ink may be printed onto the second surface of the water soluble polymer film layer, for example using a gravure printing process.

In the case of the core comprising a laminate comprising the water soluble polymer film layer, and a further layer, the layer of ink may be disposed on the surface of the water soluble polymer film layer that is not laminated to the further layer. Alternatively, the layer of ink may be disposed on the surface of the further layer (such as paper) that is not laminated to the water soluble polymer layer. For example, the layer of ink may be disposed on the surface of the further layer, for example a paper layer.

The further layer, for example paper layer, may be coloured. For example, the paper layer may comprise a pigment or colouring agent.

In the case of the core comprising a laminate comprising the water soluble polymer film layer and a further layer, the release agent may be disposed on the surface of the water soluble polymer film layer, and the adhesive layer may be disposed on the surface of the further layer or the surface of the ink layer if present; or the release agent may be disposed on the surface of the further layer or the surface of the ink layer if present, and the adhesive layer may be disposed on the surface of the water soluble polymer film layer. For example, the release agent may be disposed on the surface of the water soluble polymer film layer that is not laminated to the further layer, and the adhesive layer may be disposed on the surface of the further layer that is not laminated to the water soluble polymer film layer or the surface of the ink layer if present; or the release agent may be disposed on the surface of the further layer that is not laminated to the water soluble polymer film layer or the surface of the ink layer if present, and the adhesive layer may be disposed on the surface of the water soluble polymer film layer that is not laminated to the further layer. In the above case, the release agent may be disposed on at least a part of the above surfaces. The adhesive layer may be disposed on at least a part of the above surfaces. Alternatively, the release agent may be disposed on the entirety of the above surfaces. The adhesive layer may be disposed on the entirety of the above surfaces.

Preferably, the release agent is disposed on the surface of the water soluble polymer film layer that is not laminated to the further layer, and the adhesive layer is disposed on the surface of the further layer (or the layer of ink if present) that is not laminated to the water soluble polymer film layer. The release agent may be disposed on at least part of the surface of the water soluble polymer film layer that is not laminated to the further layer. Alternatively, the release agent may be disposed on the entire surface of the water soluble polymer film layer that is not laminated to the further layer. The adhesive layer may be disposed on at least part of the surface of the further layer that is not laminated to the water soluble polymer film layer. Alternatively, the adhesive layer may be disposed on the entire surface of the further layer that is not laminated to the water soluble polymer film layer.

Preferably, the water soluble polymer film may be directionally oriented, for example mono-axially oriented. A mono-axially oriented film may be desirable if the sheet material is converted into a tape such as a tear tape.

Preferably, the water soluble polymer film comprises a polyvinyl alcohol polymer, for example a polyvinyl alcohol copolymer. The water soluble polymer film may comprise a polyvinyl alcohol film. Polyvinyl alcohol polymers are water soluble and their ability to dissolve in water can be temperature dependent.

The polyvinyl alcohol may be formed by hydrolysis of polyvinyl acetate.

The temperature at which a polyvinyl alcohol film dissolves in water can be tuned depending on the degree of hydrolysis of the polyvinyl acetate.

The polyvinyl alcohol film may have a dissolution temperature in water of 40° C. and below, for example from 5° C. to 30° C., for example from 5° C. to 15° C.; or 40° C. to 60° C.; or 60° C. and above. For example, the polyvinyl alcohol film may dissolve in water at oceanic temperatures of under 40° C., at warm temperatures from 30° C. to 40° C. or 40° C. to 60° C. or at higher temperatures such as those used in dedicated recycling facilities, for example 60° C. and above.

In the case in which the sheet material comprises a core comprising a laminate comprising the water soluble polymer film layer and a further layer being paper, the water soluble layer may have a dissolution temperature in water of 60° C. and above. Such a dissolution temperature means that the water soluble polymer film dissolves during the high temperature recycling processes typically associated with paper or cardboard recycling. The water soluble polymer film, for example polyvinyl alcohol film, may dissolve upon agitation, for example upon stirring or shaking.

In the case in which the sheet material comprises a core that does not include a further layer being paper, then the water soluble film may have a dissolution temperature in water of 40° C. or below, for example from 5° C. to 30° C., for example from 5° C. to 15° C. Such a dissolution temperatures enable the core to dissolve, upon agitation, in aquatic environments such as the ocean.

The water soluble polymer film, for example the polyvinyl alcohol film, may comprise a plasticiser.

The core may have a thickness of from about 20 to about 70 micrometres, for example from about 50 to 70 micrometres.

The water soluble polymer film layer may have a thickness of from 30 to 60 micrometres.

In the case in which the sheet material comprises a core that does not include a laminate having a further layer being paper, then the water soluble film layer may have a thickness of from 50 to 60 micrometres. In the case in which the sheet material comprises a core comprising a laminate comprising the water soluble polymer film and a further layer being paper, the water soluble layer may have a thickness of from 30 to 50 micrometres, for example from 30 to 40 micrometres or 40 to 50 micrometres.

The release agent disposed on the first surface of the core may be a silicon based release agent, for example a silicone release polymer. The release agent may comprise a polymethyl siloxane polymer. The release agent may be applied as a solvent based polymethyl siloxane system. The release agent may form a release agent layer following application and curing.

The adhesive layer disposed on a second surface of the core may be an aqueous adhesive, for example an aqueous based dispersion adhesive. The adhesive layer may comprise a polymer formed from an acrylic ester and vinyl acetate. The adhesive layer may be applied as an aqueous dispersion of a polymer formed from an acrylic ester and vinyl acetate.

The sheet material may comprise: a core comprising a water soluble polymer film layer and a layer of ink disposed on a surface of the water soluble polymer film layer; a release agent disposed on the surface of the water soluble polymer film layer; and an adhesive layer disposed on the surface of the layer of ink.

The sheet material may comprise: a core comprising a laminate comprising a water soluble polymer film layer, a paper layer and a layer of lamination adhesive between the water soluble polymer film layer and the paper layer, and a layer of ink disposed on the paper layer; a release agent disposed on the surface of the water soluble polymer film layer; and an adhesive layer disposed on the surface of the layer of ink.

In a further aspect of the present invention, there is provided a tape comprising the sheet material according to any statement set out above. The tape may be a tear tape. The tear tape may be adhered to a substrate by the adhesive layer disposed on the second surface of the core, such that, in use, the tear tape may be pulled through the substrate to thereby form an opening in the substrate.

In a further aspect of the present invention, there is provided a tape comprising: a core comprising a water soluble polymer film layer; a release agent disposed on at least a part of a first surface of the core; and an adhesive layer disposed on a second surface of the core.

In a further aspect of the present invention there is provided a tape comprising: a core comprising a laminate comprising a water soluble polymer film layer, and a further layer comprising a cellulosic material; a release agent disposed on a first surface of the core; and an adhesive layer disposed on a second surface of the core.

In a further aspect of the present invention, there is provided packaging comprising a substrate and the tape as set out in any statement above. The tape is adhered to the substrate by the adhesive layer disposed on the second surface of the core. The substrate and tape are configured such that the tape can be pulled through substrate to thereby form an opening in the substrate.

The packaging may, for example, be packaging for food products, consumer products or the like. The packaging may be in the form of for example a pouch or a packet. The packaging may be in the form of a wrap, for example a shrink wrap or overwrap for containing one or more articles. The packaging may be in the form of a box or carton. The tear tape may aid the user in opening the packaging by helping the user to form an opening in the packaging substrate.

The substrate may comprise a polymer film or a cellulosic material such as paper, Kraft paper, card or cardboard.

In a further aspect of the present invention, there is provided a method of making a sheet material comprising: coating at least part of a first surface of a longitudinally advancing web of core material with a release agent; and coating at least a part of a second surface of the longitudinally advancing web of core material with an adhesive to form the sheet material;

wherein the core material comprises a water soluble polymer film layer.

The method may comprise a step of cutting the sheet material into a plurality of strips to thereby form a plurality of tapes.

The method may comprise a step of printing ink onto the second surface of a longitudinally advancing web of a water soluble polymer film material followed by applying an adhesive layer on top of the ink layer. The ink may be printed using a gravure printing process.

The water soluble polymer, release agent and adhesive may be any water soluble polymer, release agent and adhesive according to any statements set out above.

The method may comprise a step of forming the core material by laminating the web of water soluble polymer film layer material to a web of further material. The web of further material may comprise a polymer film, for example a further water soluble polymer film. The web of further material may comprise a cellulosic material, for example selected from paper, Kraft paper, card, cardboard and the like.

The lamination step may comprise coating a surface of the web of further material with a lamination adhesive to form a layer of lamination adhesive thereon, and then applying the web of water soluble polymer film material on to the surface of the layer of lamination adhesive to thereby form a laminate. Alternatively, the lamination step may comprise a step of coextruding the water soluble polymer film with the further layer.

The method may comprise a step of printing ink onto a surface of the laminate, for example onto a surface of the further layer.

Preferred embodiments of the present invention will now be described, by way of example only, with reference to the accompanying drawings, in which:

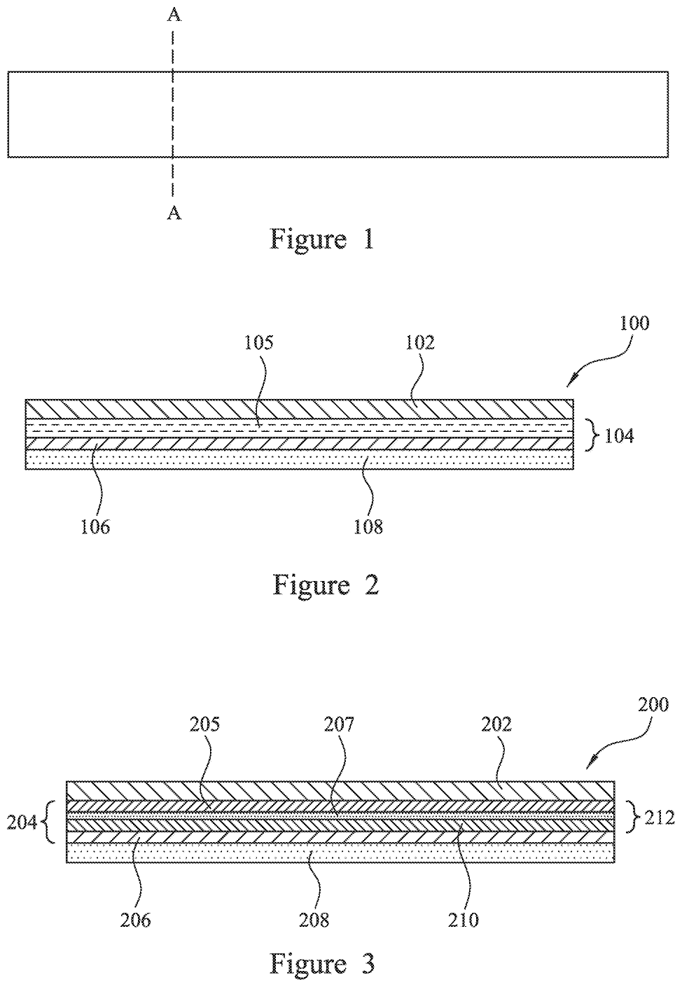

FIG. 1 is a top view of a sheet of sheet material according to the present invention;

FIG. 2 is a sectional view of a sheet of sheet material along line A-A in FIG. 1;

FIG. 3 is a sectional view of a further embodiment of a sheet of sheet material along the line A-A;

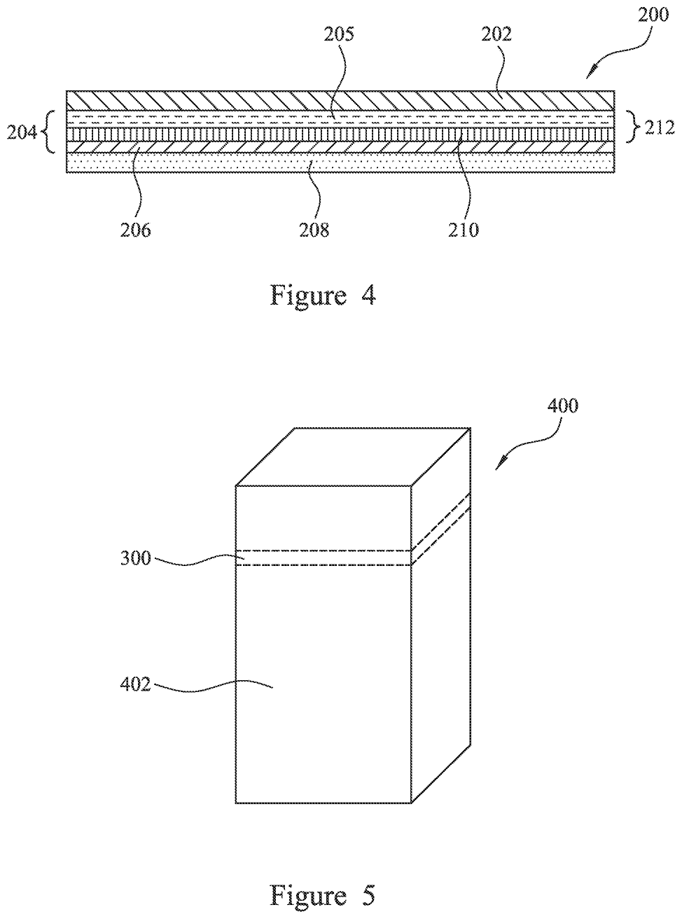

FIG. 4 is a sectional view of a further embodiment of a sheet of sheet material along the line A-A;

FIG. 5 is a perspective view of packaging according to the present invention;

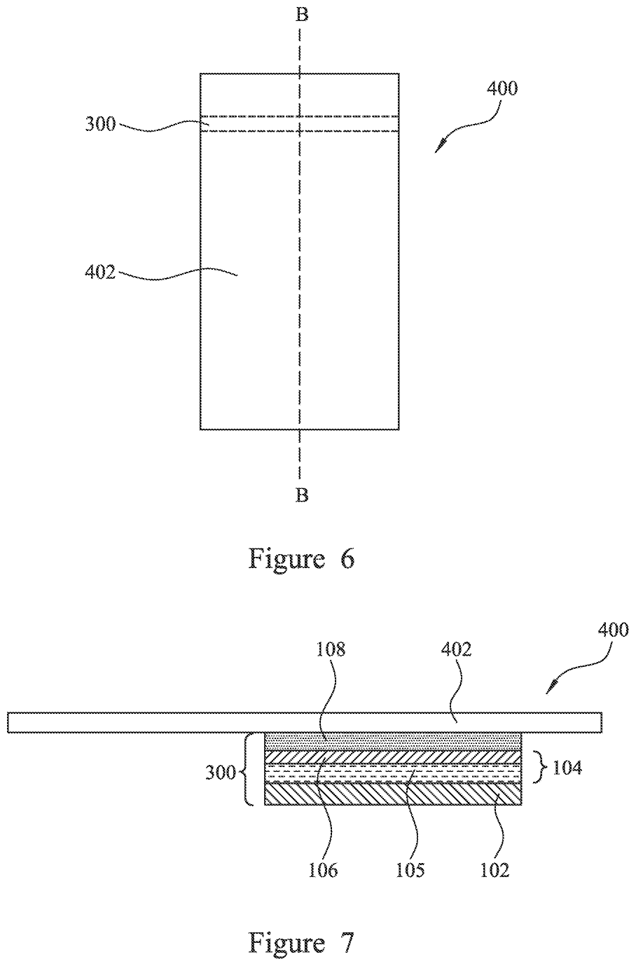

FIG. 6 is a front view of the packaging shown in FIG. 4;

FIG. 7 is a partial sectional view of the packaging shown in FIG. 6 along line B-B;

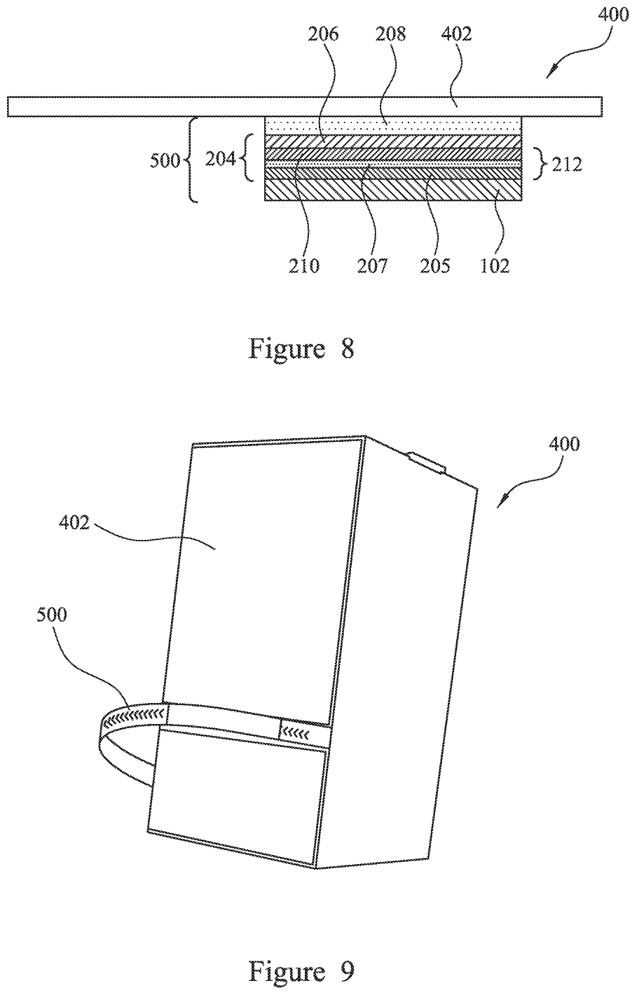

FIG. 8 is a partial sectional view of a further embodiment of the packaging shown in FIG. 6 along line B-B;

FIG. 9 is a perspective view of the packaging shown in FIG. 4 in use.

FIG. 1 shows a top view of a continuous sheet 100 of sheet material. The sheet material 100 may be used to make a tape such as a tear tape.

FIG. 2 illustrates a sectional view of an embodiment of the sheet 100 along line A-A in FIG. 1. As shown in FIG. 2, the sheet material comprises a core 104. The core 104 includes a polyvinyl alcohol film 105 having a thickness of from 50 to 60 micrometres. The polyvinyl alcohol film is an extruded film of polyvinyl alcohol. The polyvinyl alcohol film is mono-axially oriented.

The core 104 also includes a layer of ink 106 disposed on the lower surface of the polyvinyl alcohol film. The layer of ink 106 may include graphics, lettering, brand information, colour and the like.

Disposed on a first surface of the core 104 is a layer of release agent 102 in the form of a polymethyl siloxane polymer. An adhesive layer 108 in the form of a layer comprising a polymer formed from an acrylic ester and vinyl acetate is disposed on the second surface of the core, which also amounts to the free surface of the layer of ink 106. The adhesive may be present on the second surface of the core in an amount of around 29 g/m².

FIG. 3 shows a sectional view of a sheet 200 along the same line as shown in FIG. 1. The sheet 200 is similar to the sheet shown in FIG. 2, but includes a different core 204 which comprises a laminate 212 and a layer of ink 206. The laminate 212 comprises a polyvinyl alcohol film 205 which is adhered to a further layer in the form of a layer of paper 210. The polyvinyl alcohol film has a thickness of 30-40 micrometres or 40 to 50 micrometres. The paper layer has a basis weight of 77 g/m² or 80 g/m². The polyvinyl alcohol film is an extruded film of polyvinyl alcohol. The polyvinyl alcohol film 205 is mono-axially oriented. The polyvinyl alcohol film 205 is adhered to the paper 210 by means of a lamination adhesive 207. The lamination adhesive 207 may be a solventless lamination adhesive and may be present in an amount of 2 to 3 g/m².

Disposed on a first surface of the laminate 212, that is the surface of the polyvinyl alcohol film 205 that does not have a layer of lamination adhesive disposed thereon, is a layer of release agent 202 in the form of a polymethyl siloxane polymer. Disposed on a second surface of the laminate 212, that is on the surface of the paper 210 that does not have a layer of lamination adhesive disposed thereon, is a layer of ink 206. It will be appreciated that alternatively the layer of ink 206 could be disposed on the first surface of the laminate 212 and the layer of release agent 202 may be disposed on the second surface of the laminate 212. The layer of ink 206 includes graphics, lettering, brand information, colour and the like. An adhesive layer 208 in the form of layer comprising a polymer formed from an acrylic ester and vinyl acetate is disposed on the surface of the layer of ink. The adhesive may be present in an amount of 29 g/m².

FIG. 4 shows a sectional view of a sheet 200 along the same line as shown in FIG. 1.

The sheet 200 is similar to the sheet shown in FIG. 3, but the laminate 212 does not include a lamination adhesive as illustrated in FIG. 2. All of the other components of the sheet 200 illustrated in FIG. 4 are the same as described above with respect to FIG. 3.

The laminate 212 comprises a polyvinyl alcohol film 205 and a layer of paper 210. The polyvinyl alcohol film 205 is thermally bonded to the layer of paper 210. The thermal bonding may be achieved by a co-extrusion process.

The sheet material can be made according to the following example process. A web of extruded mono-axially oriented polyvinyl alcohol film is advanced in a longitudinal direction. At a printing station, ink is applied to a surface of the advancing web using a direct gravure printing process to form an ink layer that is disposed on the surface of the web. A silicone release agent precursor mixture is then applied to the other surface of the web of mono-axially oriented polyvinyl alcohol film to form a layer of silicone release agent that is disposed on the surface of the web. The silicone release agent precursor mixture may comprise a solvent based polymethyl siloxane system that also includes a cross linker agent and a catalyst. An adhesive, comprising a polymer formed from an acrylic ester and vinyl acetate, is then applied to the ink layer using a reverse gravure process to form an adhesive layer, and thereby form the sheet material.

In the case of the sheet material having a core comprising a laminate as shown in FIG. 3, the sheet material is formed according to the following example process. A web of paper is advanced in a longitudinal direction. A lamination adhesive is applied, at a low coating weight, to the web of paper using a smooth roll transfer. A web of extruded mono-axially oriented polyvinyl alcohol film is advanced and applied to the layer of lamination adhesive. At a printing station, ink is applied to the free surface of the paper layer of the advancing web using a direct gravure printing process to form an ink layer that is disposed on a first surface of the web. A silicone release agent, as described above, is then applied to the free surface of the mono-axially oriented polyvinyl alcohol film to form a layer of silicone release agent that is disposed on a second surface of the web. An adhesive, as described above, is then applied to the ink layer using a reverse gravure process to form an adhesive layer, and thereby form the sheet material.

In the case of the sheet material having a core comprising a laminate as shown in FIG. 4, the sheet material is formed according to a typical co-extrusion process.

The finished sheet material may be wound onto a spool to form a wound reel of sheet material. The wound reel may be stored for further processing. Alternatively, the longitudinally advancing web of sheet material may be subject to cutting processes, including a primary cutting stage to provide workable sheet dimensions prior to secondary cutting. Secondary cutting (secondary slitting) involves utilising specialised razor blades to slit primary cut web or sheet material to form a series of tapes at a desired width, for example from 1.6 mm to 30 mm. The tapes may then be wound onto a spool to form a wound reel of tape.

FIG. 5 shows packaging 400. The packaging includes a substrate 402 and adhered to the underside of the substrate 402 is a tear tape 300.

FIG. 6 shows a front view of the packaging 400 illustrated in FIG. 4. FIG. 7 shows a partial sectional view of the packaging 400 along line B-B shown in FIG. 6.

FIG. 7 shows the packaging substrate 402 which may be in the form of, for example, a polymer film. Adhered to the underside of the substrate 402 is a tear tape 300. The tear tape 300 is adhered to the substrate 402 by means of the adhesive layer 108.

The tear tape 300 is formed from the sheet material 100 shown in FIG. 2, and so includes a core 104 including a polyvinyl alcohol film having a thickness of from 50 to 60 micrometres. The polyvinyl alcohol film is an extruded film of polyvinyl alcohol. The polyvinyl alcohol film is mono-axially oriented. The polyvinyl alcohol film may have a dissolution temperature in water of from 5° C. to 15° C.

Disposed on a first surface of the core 104 is a layer of release agent 102 in the form of a silicone release polymer as described above. Disposed on a second surface, that is the opposing surface, of the core is a layer of ink 106. The layer of ink 106 may include graphics, lettering, brand information, colour or the like. An adhesive layer 108, as described above, is disposed on the surface of the layer of ink 106.

The tear tape 300 may include a tab (not shown) that protrudes through the substrate 402, or extends away from part of the substrate at a position where part of the substrate joins another part of the substrate. The tab may include an adhesive deadening layer disposed on the surface of the adhesive layer 108 in only the region of the tab, such that the tab can be easily grasped by the user. Upon pulling the tab, the tear tape is pulled through the substrate 402 to thereby tear the substrate to form an opening in the substrate 402 and enable access to the contents within the packaging.

The tear tape 300 can be made according to the process set out above.

The tear tape 300 may be assembled onto the packaging substrate 402 using standard techniques known in the art.

Should the tear tape enter the ocean or another aquatic environment, then it will dissolve so avoiding the problems associated with current non-biodegradable tear tape products.

FIG. 8 shows a partial sectional view of packaging 400 in which a tear tape 500 is adhered to the packaging substrate 402. The packaging substrate 402 shown in FIG. 8 is a cardboard substrate.

The tear tape 500 is formed from the sheet material 200 illustrated in FIG. 3. The tear tape 500 includes a core 204 comprising a laminate 212. The laminate 212 comprises a polyvinyl alcohol film 205 which is adhered to a further layer in the form of a paper layer 210. The polyvinyl alcohol film 205 has a thickness of 30-50 micrometres. The paper layer 210 has a basis weight of from 77 g/m² to 82 g/m². The polyvinyl alcohol film 205 is an extruded film of polyvinyl alcohol. The polyvinyl alcohol film 205 is mono-axially oriented. The polyvinyl alcohol film 205 is adhered to the paper 210 by means of a lamination adhesive 207. Alternatively, the polyvinyl alcohol film 205 may be thermally bonded to the paper layer 210. Thermal bonding may be achieved by a co-extrusion process.

Disposed on a first surface of the laminate 212, that is the surface of the polyvinyl alcohol film 205 that does not have a layer of lamination adhesive disposed thereon, is a layer of release agent 202 in the form of a silicone release polymer as described above. Disposed on a second surface of the laminate, that is on the surface of the paper 210 that does not have a layer of lamination adhesive disposed thereon, is a layer of ink 206. It will be appreciated that alternatively the layer of ink 206 could be disposed on the first surface of the laminate 212 and the layer of release agent 202 may be disposed on the second surface of the laminate 212. The layer of ink 206 includes graphics, lettering, brand information, colour or the like. An adhesive layer 208 as described above is disposed on the surface of the layer of ink.

As shown in FIG. 7, the tear tape 500 is adhered to the packaging substrate 402 via the layer of adhesive 208.

The tear tape 500 can be made according to the process set out above.

The tear tape 500 may be assembled onto the packaging substrate 402 using standard techniques known in the art.

FIG. 9 shows packaging 400 in the form of a carton comprising a cardboard packaging substrate 402, to the underside of which a tear tape 500 is adhered. FIG. 9 shows the packaging 400 in an open configuration after the tear tape 500 has been pulled to thereby tear the cardboard packaging substrate.

The tear tape can aid the consumer in opening the packaging 400 by being pulled through the packaging substrate 402 to thereby form an opening. The paper layer that forms part of the laminate 112 increases the strength of the tear tape, such that it can be used with packaging materials such as cardboard or card which have a greater resistance to tearing as compared to polymer films.

In the case of packaging formed of paper, card, cardboard or other cellulosic material, the tear tape will dissolve during standard card/cardboard recycling processes, in which the packaging will be subjected to hot water and agitation.

1. A sheet material comprising:
a core comprising a water soluble polymer film layer;
a release agent disposed on a first surface of the core; and
an adhesive layer disposed on a second surface of the core.

2. The sheet material according to claim 1, wherein the core comprises a laminate comprising the water soluble polymer film layer, and a further layer.

3. The sheet material according to claim 2, wherein the further layer comprises a cellulosic material.

4. The sheet material according to claim 2, wherein the laminate comprises a layer of lamination adhesive disposed between the water soluble polymer film layer and the further layer.

5. The sheet material according to claim 4, wherein the lamination adhesive is a solventless lamination adhesive or an aqueous adhesive.

6. The sheet material according to claim 2, wherein the water soluble polymer film layer and the further layer are thermally bonded.

7. The sheet material according to claim 1, wherein the core comprises a layer of ink; and wherein the adhesive layer or the release agent is disposed on the layer of ink.

8. The sheet material according to claim 2, wherein the release agent is disposed on the surface of the water soluble polymer film layer.

9. The sheet material according to claim 2, wherein the adhesive layer is disposed on a surface of the further layer.

10. The sheet material according to claim 1, wherein the water soluble polymer film layer is mono-axially oriented.

11. The sheet material according to claim 1, wherein the water soluble polymer film layer comprises polyvinyl alcohol.

12. The sheet material according to claim 11, wherein the polyvinyl alcohol is formed by hydrolysis of polyvinyl acetate.

13. The sheet material according to claim 1, wherein the water soluble polymer film layer comprises a plasticiser.

14. The sheet material according to claim 1 wherein:
the core further comprises a layer of ink disposed on a surface of the water soluble polymer film layer; and
the adhesive layer is disposed on a surface of the layer of ink.

15. The sheet material according to claim 2, wherein:
the core further comprises a paper layer and a layer of lamination adhesive between the water soluble polymer film layer and the paper layer, and a layer of ink disposed on the paper layer; and
the adhesive layer is disposed on a surface of the layer of ink.

16. A tape comprising the sheet material according to claim 1.

17. The tape according to claim 16, wherein the tape is a tear tape.

18. A tape comprising:
a core comprising a water soluble polymer film layer;
a release agent disposed on a first surface of the core; and
an adhesive layer disposed on a second surface of the core.

19. A tape comprising:
a core comprising a laminate comprising a water soluble polymer film layer and a further layer comprising a cellulosic material;
a release agent disposed on a first surface of the core; and
an adhesive layer disposed on a second surface of the core.

20. Packaging comprising:
a substrate; and
the tape according to claim 16;
wherein the tape is adhered to the substrate by the adhesive layer; and
wherein the substrate and the tape are configured such that the tape can be pulled through the substrate to thereby form an opening in the substrate.

21. The packaging according to claim 20, wherein the substrate comprises a cellulosic material.

22. The packaging according to claim 21, wherein the substrate comprises a polymer film.

23. A method of making a sheet material comprising:
coating at least part of a first surface of a longitudinally advancing web of core material with a release agent; and
coating at least part of a second surface of the longitudinally advancing web of core material with an adhesive to form the sheet material;
wherein the core material comprises a water soluble polymer film layer.

24. The method according to claim 23 comprising a step of cutting the sheet material into a plurality of strips.

25. The method according to claim 23, wherein the core material comprises a laminate;
wherein the laminate is formed by advancing a web of a water soluble polymer film layer material; advancing a web of further material; coating a surface of the web of further material with a lamination adhesive to form a layer of lamination adhesive thereon; and applying the web of the water soluble polymer film layer material to the surface of the layer of lamination adhesive to thereby form a laminate.
